(19) United States
(12) Patent Application Publication
(10) Pub. No.: US 2022/0067787 A1
(43) Pub. Date: Mar. 3, 2022

(54) CONTROL APPARATUS, SYSTEM, NON-TRANSITORY COMPUTER READABLE MEDIUM, AND ADVERTISEMENT DISPLAY METHOD

(71) Applicant: Toyota Jidosha Kabushiki Kaisha, Toyota-shi Aichi-ken (JP)

(72) Inventors: Yuta Kodama, Toyota-shi Aichi-ken (JP); Hideo Hasegawa, Nagoya-shi Aichi-ken (JP); Rio Minagawa, Nagoya-shi Aichi-Ken (JP); Corentin Marie C. Mossoux, Toyota-shi Aichi-ken (JP); Chris Risberg, Flower Mound, TX (US)

(21) Appl. No.: 17/408,978

(22) Filed: Aug. 23, 2021

(30) Foreign Application Priority Data
Aug. 25, 2020 (JP) 2020-142099

(51) Int. Cl. G06Q 30/02; G09F 9/30; G08G 1/01

(52) U.S. Cl. CPC G06Q 30/0269; G06Q 30/0201; G09F 9/30; G06F 3/14; G08G 1/0137; G08G 1/0112; G08G 1/0125

(57) ABSTRACT

A control apparatus includes a controller configured to acquire destination data indicating a destination of at least one vehicle, and when the at least one vehicle travels through a section, on a road, from which an advertising sign installed outdoors is visible, perform control to display, on the advertising sign, an advertisement that is customized according to the destination indicated by the destination data.

### CROSS-REFERENCE TO RELATED APPLICATION

This application claims priority to Japanese Patent Application No. 2020-142099, filed on Aug. 25, 2020, the entire contents of which are incorporated herein by reference.

### TECHNICAL FIELD

The present disclosure relates to a control apparatus, a system, a program, and an advertisement display method.

### BACKGROUND

Patent Literature (PTL) 1 discloses an information processing system that communicates with a vehicle having entered a road area, and presents advertisement information to the vehicle having entered the road area.

### CITATION LIST

### Patent Literature

PTL 1: WO 2012/043394 A1

### SUMMARY

The conventional information processing system often presents advertisements that are of little interest to people who are traveling in vehicles toward destinations.

It would be helpful to present an advertisement beneficial to a person who is traveling in a vehicle toward a destination.

A control apparatus according to the present disclosure includes a controller configured to:

acquire destination data indicating a destination of at least one vehicle; and

when the at least one vehicle travels through a section, on a road, from which an advertising sign installed outdoors is visible, perform control to display, on the advertising sign, an advertisement that is customized according to the destination indicated by the destination data.

A program according to the present disclosure is configured to cause a computer to execute operations, the operations comprising:

acquiring destination data indicating a destination of at least one vehicle; and

when the at least one vehicle travels through a section, on a road, from which an advertising sign installed outdoors is visible, performing control to display, on the advertising sign, an advertisement that is customized according to the destination indicated by the destination data.

An advertisement display method according to the present disclosure includes:

acquiring, by a computer, destination data indicating a destination of at least one vehicle; and

when the at least one vehicle travels through a section, on a road, from which an advertising sign installed outdoors is visible, displaying, on the advertising sign, an advertisement that is customized according to the destination indicated by the destination data.

According to the present disclosure, it is possible to present an advertisement beneficial to a person who is traveling in a vehicle toward a destination.

### BRIEF DESCRIPTION OF THE DRAWINGS

In the accompanying drawings:

FIG. 1 is a diagram illustrating a configuration of a system according to a first embodiment of the present disclosure;

FIG. 2 is a block diagram illustrating a configuration of a control apparatus according to the first embodiment of the present disclosure;

FIG. 3 is a flowchart illustrating operations of the control apparatus according to the first embodiment of the present disclosure;

FIG. 4 is a flowchart illustrating operations of the control apparatus according to a second embodiment of the present disclosure;

FIG. 5 is a flowchart illustrating operations of the control apparatus according to a third embodiment of the present disclosure; and

FIG. 6 is a flowchart illustrating operations of the control apparatus according to a fourth embodiment of the present disclosure.

### DETAILED DESCRIPTION

Hereinafter, some embodiments of the present disclosure will be described with reference to the drawings.

In the drawings, the same or corresponding portions are denoted by the same reference numerals. In the descriptions of the embodiments, detailed descriptions of the same or corresponding portions are omitted or simplified, as appropriate.

A first embodiment, an embodiment of the present disclosure, will be described.

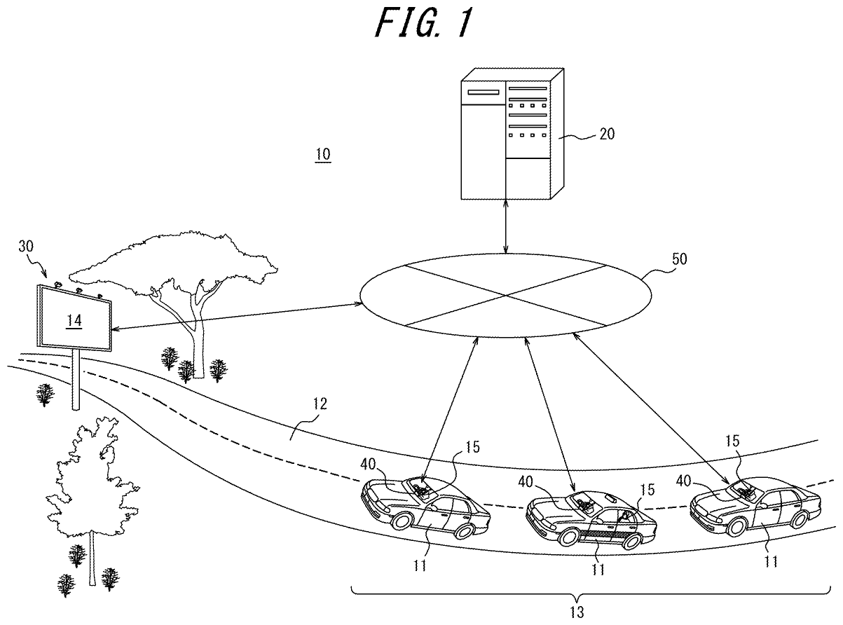

An outline of the present embodiment will be described with reference to FIG. 1.

In the present embodiment, destination data D1 indicating a destination of at least one vehicle 11 is acquired by a control apparatus 20. When the at least one vehicle 11 travels through a section 13, on a road 12, from which an advertising sign 30 installed outdoors is visible, an advertisement 14 that is customized according to the destination indicated by the destination data D1 is displayed on the advertising sign 30.

According to the present embodiment, it is possible to present an advertisement 14 beneficial to a person 15 who is traveling in the vehicle 11 toward a destination. For example, it is possible to display, on the advertising sign 30, an outdoor advertisement regarding a POI such as a restaurant, a hotel, a sightseeing spot, a park, an amusement park, a movie theater, a convenience store, a supermarket, a shopping mall, a department store, a pharmacy, a station, an airport, a parking lot, a hospital, a post office, or a bank in the vicinity of the destination. The term “POI” is an abbreviation of point of interest.

A configuration of a system 10 according to the present embodiment will be described with reference to FIG. 1.

The system 10 according to the present embodiment includes at least one control apparatus 20, at least one advertising sign 30, and at least one terminal apparatus 40.

The control apparatus 20 is installed in a facility such as a data center. The control apparatus 20 is a computer such as a server that belongs to a cloud computing system or another type of computing system.

The advertising sign 30 is installed outdoors. The advertising sign 30 is installed along a road 12 in the present embodiment, but may be installed as an overhead type, across the road 12, or may be installed at any other location such that an advertisement 14 is visible from the road 12. The advertising sign 30 is, for example, digital signage.

The terminal apparatus 40 is mounted or installed in a vehicle 11. Alternatively, the terminal apparatus 40 is held by a person 15 who is on board the vehicle 11. The person 15 who is on board the vehicle 11 is specifically a driver, a passenger, or another occupant. The terminal apparatus 40 is, for example, an in-vehicle device such as a car navigation device, a mobile device such as a mobile phone, a smartphone, or a tablet, or a PC. The term “PC” is an abbreviation of personal computer.

The vehicle 11 is, for example, any type of automobile such as a gasoline vehicle, a diesel vehicle, an HV, a PHV, an EV, or an FCV. The term “HV” is an abbreviation of hybrid vehicle. The term “PHV” is an abbreviation of plug-in hybrid vehicle. The term “EV” is an abbreviation of electric vehicle. The term “FCV” is an abbreviation of fuel cell vehicle. The vehicle 11 is driven by a driver in the present embodiment, but the driving may be automated at any level. The automation level is, for example, any one of Level 1 to Level 5 according to the level classification defined by SAE. The name “SAE” is an abbreviation of Society of Automotive Engineers. The vehicle 11 may be a MaaS-dedicated vehicle. The term “MaaS” is an abbreviation of Mobility as a Service.

The control apparatus 20 can communicate with the advertising sign 30 and the terminal apparatus 40 via a network 50.

The network 50 includes the Internet, at least one WAN, at least one MAN, or a combination thereof. The term “WAN” is an abbreviation of wide area network. The term “MAN” is an abbreviation of metropolitan area network. The network 50 may include at least one wireless network, at least one optical network, or a combination thereof. The wireless network is, for example, an ad hoc network, a cellular network, a wireless LAN, a satellite communication network, or a terrestrial microwave network. The term “LAN” is an abbreviation of local area network.

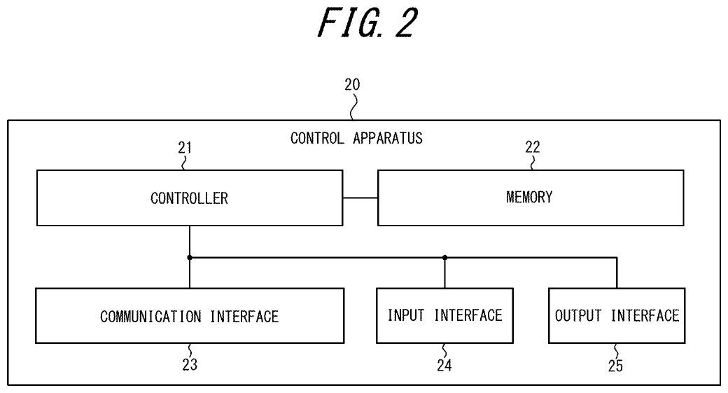

A configuration of the control apparatus 20 according to the present embodiment will be described with reference to FIG. 2.

The control apparatus 20 includes a controller 21, a memory 22, a communication interface 23, an input interface 24, and an output interface 25.

The controller 21 includes at least one processor, at least one dedicated circuit, or a combination thereof. The processor is a general purpose processor such as a CPU or a GPU, or a dedicated processor that is dedicated to specific processing. The term “CPU” is an abbreviation of central processing unit. The term “GPU” is an abbreviation of graphics processing unit. The dedicated circuit is, for example, an FPGA or an ASIC. The term “FPGA” is an abbreviation of field-programmable gate array. The term “ASIC” is an abbreviation of application specific integrated circuit. The controller 21 executes processes related to operations of the control apparatus 20 while controlling components of the control apparatus 20.

The memory 22 includes at least one semiconductor memory, at least one magnetic memory, at least one optical memory, or a combination of at least two of these. The semiconductor memory is, for example, RAM or ROM. The term “RAM” is an abbreviation of random access memory. The term “ROM” is an abbreviation of read only memory. The RAM is, for example, SRAM or DRAM. The term “SRAM” is an abbreviation of static random access memory. The term “DRAM” is an abbreviation of dynamic random access memory. The ROM is, for example, EEPROM. The term “EEPROM” is an abbreviation of electrically erasable programmable read only memory. The memory 22 functions as, for example, a main memory, an auxiliary memory, or a cache memory. The memory 22 stores data to be used for the operations of the control apparatus 20 and data obtained by the operations of the control apparatus 20.

The communication interface 23 includes at least one interface for communication. The interface for communication is, for example, a LAN interface. The communication interface 23 receives data to be used for the operations of the control apparatus 20, and transmits data obtained by the operations of the control apparatus 20.

The input interface 24 includes at least one interface for input. The interface for input is, for example, a physical key, a capacitive key, a pointing device, a touch screen integrally provided with a display, a camera, or a microphone. The input interface 24 accepts an operation for inputting data to be used for the operations of the control apparatus 20. The input interface 24, instead of being included in the control apparatus 20, may be connected to the control apparatus 20 as an external input device. As the connection method, any technology such as USB, HDMI© (HDMI is a registered trademark in Japan, other countries, or both), or Bluetooth® (Bluetooth is a registered trademark in Japan, other countries, or both) can be used. The term “USB” is an abbreviation of Universal Serial Bus. The term “HDMI®” is an abbreviation of High-Definition Multimedia Interface.

The output interface 25 includes at least one interface for output. The interface for output is, for example, a display or a speaker. The display is, for example, an LCD or an organic EL display. The term “LCD” is an abbreviation of liquid crystal display. The term “EL” is an abbreviation of electro luminescence. The output interface 25 outputs data obtained by the operations of the control apparatus 20. The output interface 25, instead of being included in the control apparatus 20, may be connected to the control apparatus 20 as an external output device. As the connection method, any technology such as USB, HDMI®, or Bluetooth® can be used.

The functions of the control apparatus 20 are realized by execution of a control program according to the present embodiment by a processor serving as the controller 21. That is, the functions of the control apparatus 20 are realized by software. The control program causes a computer to execute the operations of the control apparatus 20, thereby causing the computer to function as the control apparatus 20. That is, the computer executes the operations of the control apparatus 20 in accordance with the control program to thereby function as the control apparatus 20.

The program can be stored on a non-transitory computer readable medium. The non-transitory computer readable medium is, for example, flash memory, a magnetic recording device, an optical disc, a magneto-optical recording medium, or ROM. The program is distributed, for example, by selling, transferring, or lending a portable medium such as an SD card, a DVD, or a CD-ROM on which the program is stored. The term “SD” is an abbreviation of Secure Digital. The term “DVD” is an abbreviation of digital versatile disc. The term “CD-ROM” is an abbreviation of compact disc read only memory. The program may be distributed by storing the program in a storage of a server and transferring the program from the server to another computer. The program may be provided as a program product.

For example, the computer temporarily stores, in a main memory, a program stored in a portable medium or a program transferred from a server. Then, the computer reads the program stored in the main memory using a processor, and executes processes in accordance with the read program using the processor. The computer may read a program directly from the portable medium, and execute processes in accordance with the program. The computer may, each time a program is transferred from the server to the computer, sequentially execute processes in accordance with the received program. Instead of transferring a program from the server to the computer, processes may be executed by a so-called ASP type service that realizes functions only by execution instructions and result acquisitions. The term “ASP” is an abbreviation of application service provider. Programs encompass information that is to be used for processing by an electronic computer and is thus equivalent to a program. For example, data that is not a direct command to a computer but has a property that regulates processing of the computer is “equivalent to a program” in this context.

Some or all of the functions of the control apparatus 20 may be realized by a dedicated circuit serving as the controller 21. That is, some or all of the functions of the control apparatus 20 may be realized by hardware.

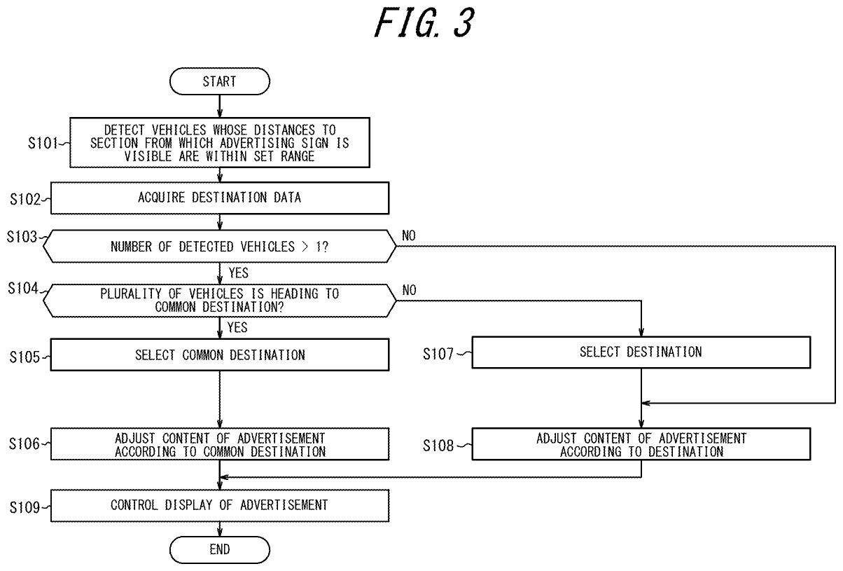

Operations of the system 10 according to the present embodiment will be described with reference to FIG. 3. These operations correspond to an advertisement display method according to the present embodiment. FIG. 3 illustrates operations of the control apparatus 20.

In step S101, the controller 21 detects, as at least one vehicle 11, vehicles V1, V2, . . . , Vn whose distances to a section 13, on a road 12, from which the advertising sign 30 is visible are within a set range R, where n is an integer equal to or greater than one.

The set range R may be set to any range, but in the present embodiment, is set according to the standard time period T from when the process in step S101 is performed until the process in step S109 is performed, and the length L of the section 13. Specifically, the lower limit Rmin of the set range R is set to a value equal to or greater than the product of the standard vehicle speed E on the road 12 and the time period T. That is, Rmin≥ET. The upper limit Rmax of the set range R is set to a value less than or equal to the sum of the lower limit Rmin and the length L of the section 13. That is, Rmin≤Rmax≤Rmin+L.

For example, assuming that the distance from vehicle V1 to the section 13 is equal to the lower limit Rmin, the controller 21 detects vehicle V1. If vehicle V1 continues to travel at the speed E, the controller 21 can perform the process in step S109 after detecting vehicle V1 and before vehicle V1 enters the section 13. Assuming that the distance from vehicle V2 to the section 13 is greater than the lower limit Rmin and less than the upper limit Rmax when vehicle V1 is detected, the controller 21 further detects vehicle V2. Assuming that the distance from vehicle V3 to the section 13 is equal to the upper limit Rmax when vehicle V1 is detected, the controller 21 further detects vehicle V3. If vehicle V2 and vehicle V3 continue to travel at the speed E, the controller 21 can perform the process in step S109 when the three vehicles V1, V2, and V3 travel through the section 13 simultaneously.

The vehicle 11 may be detected in any procedure, but in the present embodiment, is detected in the following procedure.

The communication interface 23 receives positional data D2 from the terminal apparatus 40. The positional data D2 is data indicating the position of the vehicle 11. Specifically, the positional data D2 is data indicating a position measured by a GNSS receiver embedded in or connected to the terminal apparatus 40. The term “GNSS” is an abbreviation of global navigation satellite system. GNSS is, for example, GPS, QZSS, GLONASS, Galileo, or any combination thereof. The term “GPS” is an abbreviation of Global Positioning System. The term “QZSS” is an abbreviation of Quasi-Zenith Satellite System. QZSS satellites are called quasi-zenith satellites. The term “GLONASS” is an abbreviation of Global Navigation Satellite System. The controller 21 acquires the positional data D2 received by the communication interface 23. The controller 21 calculates, with reference to map data D3, the distance between the position indicated by the acquired positional data D2 and the position of the beginning of the section 13. The map data D3 includes data indicating the position of the beginning of the section 13, or data for calculating the position of the beginning of the section 13. The map data D3 may be stored in advance in the memory 22, or may be accumulated in an external system such as an Internet-based GIS. The term “GIS” is an abbreviation of geographic information system. The controller 21 determines whether the calculated distance is within the set range R. The controller 21 determining that the calculated distance is within the set range R corresponds to the controller 21 detecting the vehicle 11.

For example, assuming that the distance between the position of vehicle V1 indicated by the positional data D2 and the position of the beginning of the section 13 indicated by the map data D3 is equal to the lower limit Rmin, the controller 21 detects vehicle V1. Assuming that the distance between the position of vehicle V2 indicated by the positional data D2 and the position of the beginning of the section 13 indicated by the map data D3 is greater than the lower limit Rmin and less than the upper limit Rmax, the controller 21 further detects vehicle V2. Assuming that the distance between the position of vehicle V3 indicated by the positional data D2 and the position of the beginning of the section 13 indicated by the map data D3 is equal to the upper limit Rmax, the controller 21 further detects vehicle V3.

Instead of directly determining that the distance from the vehicle 11 to the section 13 is within the set range R, acquiring data transmitted when the distance from the vehicle 11 to the section 13 is within the set range R may correspond to detecting the vehicle 11. In such a variation, an antenna compliant with any wireless communication method, such as DSRC, is installed on or near the road 12. The term “DSRC” is an abbreviation of dedicated short-range communications. The coverage area of the antenna is adjusted so that the distance to the section 13 from any position in the area is within the set range R. When the vehicle 11 travels through the coverage area, data is transmitted to the antenna from a wireless communication device embedded in or connected to the terminal apparatus 40. The communication interface 23 receives the data from the antenna. The controller 21 detects the vehicle 11 by acquiring the data received by the communication interface 23.

Instead of directly determining that the distance from the vehicle 11 to the section 13 is within the set range R, analyzing an image captured when the distance from the vehicle 11 to the section 13 is within the set range R may correspond to detecting the vehicle 11. In such a variation, a camera with a resolution high enough to recognize vehicle registration numbers printed on license plates is installed on or near the road 12. The coverage area of the camera is adjusted so that the distance to the section 13 from any position in the area is within the set range R. When the vehicle 11 travels through the coverage area, an image of the vehicle 11 is captured by the camera. The communication interface 23 receives the image from the camera. The controller 21 detects the vehicle 11 from the image received by the communication interface 23.

In step S102, the controller 21 acquires destination data D1. The destination data D1 is data indicating a destination of at least one vehicle 11. That is, the destination data D1 is data indicating destinations of vehicles V1, V2, . . . , Vn detected in step S101.

The destination data D1 may be acquired in any procedure, but in the present embodiment, is acquired in the following procedure.

The communication interface 23 receives the destination data D1 from the terminal apparatus 40. The controller 21 acquires the destination data D1 received by the communication interface 23.

For example, assuming that vehicle V1 is detected in step S101 and a car navigation device serving as the terminal apparatus 40 is mounted in vehicle V1, the controller 21 acquires, as the destination data D1, data indicating a destination set in the car navigation device. Assuming that vehicle V2 is detected in step S101 and a passenger who holds a smartphone serving as the terminal apparatus 40 is on board vehicle V2, the controller 21 acquires, as the destination data D1, data indicating a destination set in a map application running on the smartphone. Assuming that vehicle V3 is detected in step S101 and a tablet serving as the terminal apparatus 40 is installed in vehicle V3, the controller 21 acquires, as the destination data D1, data indicating a destination set in a car navigation application running on the tablet.

In step S103, the controller 21 determines whether the number of vehicles V1, V2, . . . , Vn detected in step S101 is two or more. If two or more, that is, n>1, the process in step S104 is performed. If one, that is, n=1, the process in step S108 is performed.

In step S104, the controller 21 determines whether a plurality of vehicles W that is included in the two or more vehicles V1, V2, . . . , Vn detected in step S101 is heading to a common destination. That is, the controller 21 determines whether a common destination of a plurality of vehicles W is included in the destinations that are indicated by the destination data D1 acquired in step S102. In a case in which a common destination is included, the process in step S105 is performed. In a case in which a common destination is not included, the process in step S107 is performed.

In step S105, the controller 21 selects the common destination of the plurality of vehicles W from among the destinations that are indicated by the destination data D1 acquired in step S102. In the present embodiment, the controller 21 selects, as the common destination, a destination to which the largest number of vehicles among the two or more vehicles V1, V2, . . . , Vn detected in step S101 are heading.

For example, in a case in which vehicle V1, vehicle V2, and vehicle V3 are detected in step S101, data indicating the destinations of these three vehicles V1, V2, and V3 is acquired as the destination data D1 in step S102. Assuming that vehicle V1 and vehicle V2 are heading to a common destination, and vehicle V3 is heading to a different destination, the controller 21 selects the destination to which the two vehicles V1 and V2 are heading as the common destination of the plurality of vehicles W. That is, W={V1, V2}.

In step S106, the controller 21 adjusts the content of an advertisement 14 according to the common destination selected in step S105. For example, the controller 21 acquires, from the memory 22 or external storage, advertising text, an advertising image, or a combination thereof regarding a POI such as a restaurant, a hotel, a sightseeing spot, a park, an amusement park, a movie theater, a convenience store, a supermarket, a shopping mall, a department store, a pharmacy, a station, an airport, a parking lot, a hospital, a post office, or a bank in the vicinity of the selected destination. The controller 21 edits the acquired advertising text, the acquired advertising image, or a combination thereof to generate an advertisement 14 for display. Then, the controller 21 performs the process in step S109.

In step S107, the controller 21 selects any one destination from among the destinations that are indicated by the destination data D1 acquired in step S102.

For example, in a case in which vehicle V1, vehicle V2, and vehicle V3 are detected in step S101, data indicating the destinations of these three vehicles V1, V2, and V3 is acquired as the destination data D1 in step S102. Assuming that vehicle V1, vehicle V2, and vehicle V3 are heading to destinations different from each other, the controller 21 selects the destination to which any one of the three vehicles V1, V2, and V3 is heading. Specifically, the controller 21 selects the destination to which the leading vehicle V1 among the three vehicles V1, V2, and V3 is heading. Alternatively, the controller 21 selects the destination to which vehicle V1, vehicle V2, or vehicle V3 is heading in accordance with any other criteria.

In step S108, the controller 21 adjusts the content of an advertisement 14 according to the destination selected in step S107. Alternatively, the controller 21 adjusts the content of an advertisement 14 according to the destination of vehicle V1 in a case in which only vehicle V1 is detected in step S101. For example, the controller 21 acquires, from the memory 22 or external storage, advertising text, an advertising image, or a combination thereof regarding a POI in the vicinity of the selected destination or the destination of vehicle V1. The controller 21 edits the acquired advertising text, the acquired advertising image, or a combination thereof to generate an advertisement 14 for display. Then, the controller 21 performs the process in step S109.

In step S109, when at least one vehicle 11 travels through the section 13, on the road 12, from which the advertising sign 30 is visible, the controller 21 performs control to display, on the advertising sign 30, an advertisement 14 that is customized according to a destination that is indicated by the destination data D1 acquired in step S102. That is, when vehicles V1, V2, . . . , Vn detected in step S101 travel through the section 13, the controller 21 performs control to display, on the advertising sign 30, the advertisement 14 the content of which is adjusted in step S106 or step S108.

The control to display the advertisement 14 on the advertising sign 30 may be performed in any procedure, but in the present embodiment, is performed in the following procedure.

The controller 21 controls the communication interface 23 to transmit the advertisement 14 generated in step S106 or step S108. The communication interface 23 transmits the advertisement 14 to the advertising sign 30. The advertising sign 30 receives the advertisement 14 transmitted by the communication interface 23. The advertising sign 30 displays the received advertisement 14. The length of a time period during which the advertisement 14 is to be displayed on the advertising sign 30 may be set in advance as a fixed length, or may be determined by the controller 21 according to the time frame in which vehicles V1, V2, . . . , Vn detected in step S101 travel through the section 13, and directed to the advertising sign 30 via the communication interface 23.

As described above, in the present embodiment, the controller 21 of the control apparatus 20 acquires destination data D1 indicating a destination of at least one vehicle 11. When the at least one vehicle 11 travels through a section 13, on a road 12, from which the advertising sign 30 installed outdoors is visible, the controller 21 performs control to display, on the advertising sign 30, an advertisement 14 that is customized according to the destination indicated by the destination data D1.

According to the present embodiment, it is possible to present an advertisement 14 beneficial to a person 15 who is traveling in the vehicle 11 toward a destination. As a result, it is expected that the advertisement 14 may be more effective in promotion.

In the present embodiment, in a case in which data indicating destinations of two or more vehicles V1, V2, . . . , Vn traveling through the section 13 simultaneously is acquired as the destination data D1, the controller 21 of the control apparatus 20 selects at least one destination from among the destinations indicated by the destination data D1. In a case in which a common destination of a plurality of vehicles W is included in the destinations indicated by the destination data D1, the common destination is selected as the at least one destination. In a case in which a common destination is not included, one destination is selected as the at least one destination. The controller 21 adjusts the content of an advertisement 14 according to the selected destination.

According to the present embodiment, it is expected that the advertisement 14 may be even more effective in promotion.

As a variation of the first embodiment, the content of an advertisement 14 may be adjusted according to not only a destination to which the vehicle 11 is heading but also an attribute of a person 15 who is on board the vehicle 11. A second embodiment, such a variation, will be described.

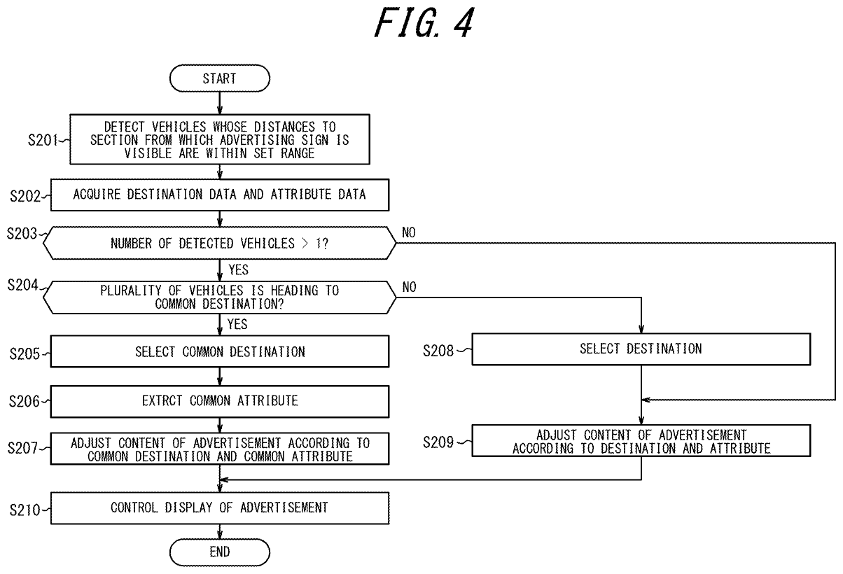

Operations of the system 10 according to the present embodiment will be described with reference to FIG. 4. These operations correspond to an advertisement display method according to the present embodiment. FIG. 4 illustrates operations of the control apparatus 20.

The process in step S201 is the same as the process in step S101 of FIG. 3, and thus a description thereof is omitted.

In step S202, the controller 21 acquires destination data D1 and attribute data D4. The attribute data D4 is data indicating an attribute of a person 15 who is on board at least one vehicle 11. That is, the attribute data D4 is data indicating an attribute of a driver, a passenger, or another occupant of each of vehicles V1, V2, . . . , Vn detected in step S201. The attribute includes, for example, the gender, the age, the family structure, the place of residence, the hometown, the occupation, the educational background, hobbies, preferences, or any combination thereof.

The attribute data D4 may be acquired in any procedure, but in the present embodiment, is acquired in the following procedure.

The communication interface 23 receives the attribute data D4 from the terminal apparatus 40. The controller 21 acquires the attribute data D4 received by the communication interface 23.

For example, assuming that vehicle V1 is detected in step S201 and a car navigation device serving as the terminal apparatus 40 is mounted in vehicle V1, the controller 21 acquires, as the attribute data D4, data indicating an attribute of the driver registered in the car navigation device. Assuming that vehicle V2 is detected in step S201 and a passenger who holds a smartphone serving as the terminal apparatus 40 is on board vehicle V2, the controller 21 acquires, as the attribute data D4, data indicating an attribute of the passenger registered in the smartphone. Assuming that vehicle V3 is detected in step S201 and a tablet serving as the terminal apparatus 40 is installed in vehicle V3, the controller 21 acquires, as the attribute data D4, data indicating an attribute of an occupant registered in the tablet.

The processes in step S203 to step S205 are the same as the processes in step S103 to step S105 of FIG. 3, and thus descriptions thereof are omitted.

In step S206, the controller 21 extracts a common attribute of people who are on board a plurality of vehicles W heading to a common destination among the two or more vehicles V1, V2, . . . , Vn detected in step S201. In the present embodiment, the controller 21 extracts the common attribute with reference to the attribute data D4 acquired in step S202. For example, assuming that three persons, a 21-year-old, a 25-year-old, and a 29-year-old are on board the plurality of vehicles W, the controller 21 extracts a common attribute of “20s”.

In step S207, the controller 21 adjusts the content of an advertisement 14 according to the common destination selected in step S205 and the common attribute extracted in step S206. For example, the controller 21 acquires, from the memory 22 or external storage, advertising text, an advertising image, or a combination thereof regarding a POI that is in the vicinity of the selected destination and popular with people having the extracted attribute. The controller 21 edits the acquired advertising text, the acquired advertising image, or a combination thereof to generate an advertisement 14 for display. Then, the controller 21 performs the process in step S210.

The process in step S208 is the same as the process in step S107 of FIG. 3, and thus a description thereof is omitted.

In step S209, the controller 21 adjusts the content of an advertisement 14 according to the destination selected in step S208 and an attribute of a person 15 who is on board vehicle Vx heading to the selected destination among the two or more vehicles V1, V2, . . . , Vn detected in step S201. Alternatively, the controller 21 adjusts the content of an advertisement 14 according to the destination of vehicle V1 and an attribute of a person 15 who is on board vehicle V1 in a case in which only vehicle V1 is detected in step S201. For example, the controller 21 acquires, from the memory 22 or external storage, advertising text, an advertising image, or a combination thereof regarding a POI that is in the vicinity of the selected destination or the destination of vehicle V1 and popular with people having the same attribute as the person 15 who is on board vehicle Vx or vehicle V1. The controller 21 edits the acquired advertising text, the acquired advertising image, or a combination thereof to generate an advertisement 14 for display. Then, the controller 21 performs the process in step S210.

The process in step S210 is the same as the process in step S109 of FIG. 3, and thus a description thereof is omitted.

As another variation of the first embodiment, in a case in which a plurality of destinations having a common characteristic is included in destinations indicated by the destination data D1, the content of an advertisement 14 may be adjusted according to the common characteristic. A third embodiment, such a variation, will be described.

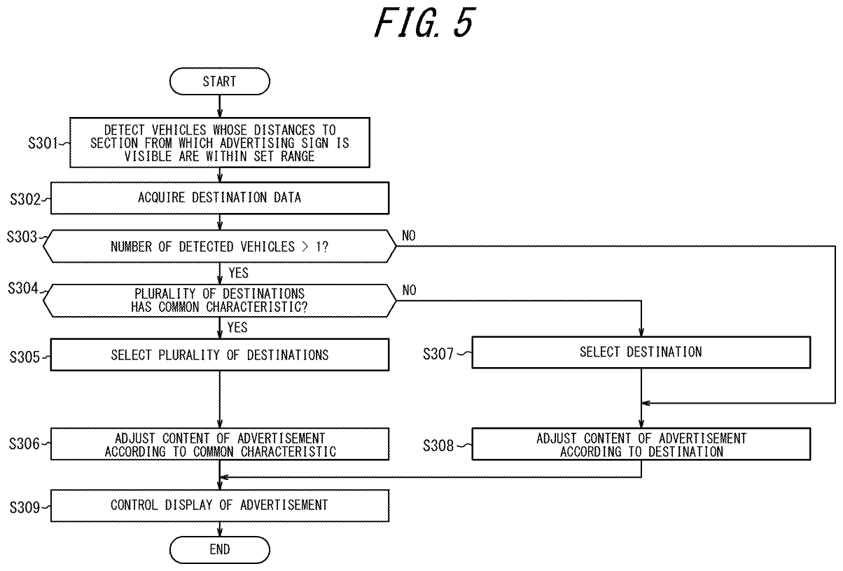

Operations of the system 10 according to the present embodiment will be described with reference to FIG. 5. These operations correspond to an advertisement display method according to the present embodiment. FIG. 5 illustrates operations of the control apparatus 20.

The processes in step S301 to step S303 are the same as the processes in step S101 to step S103 of FIG. 3, and thus descriptions thereof are omitted.

In step S304, the controller 21 determines whether a plurality of destinations having a common characteristic is included in the destinations that are indicated by the destination data D1 acquired in step S302. In a case in which such a plurality of destinations is included, the process in step S305 is performed. In a case in which such a plurality of destinations is not included, the process in step S307 is performed.

In step S305, the controller 21 selects the plurality of destinations having the common characteristic from among the destinations that are indicated by the destination data D1 acquired in step S302.

For example, in a case in which vehicle V1, vehicle V2, and vehicle V3 are detected in step S301, data indicating the destinations of these three vehicles V1, V2, and V3 is acquired as the destination data D1 in step S302. Assuming that the destinations of vehicle V1 and vehicle V2 exist in a common area, and the destination of vehicle V3 exists in a different area, the controller 21 selects the destinations to which the two vehicles V1 and V2 are heading, having a common characteristic of existing in the common area. Alternatively, assuming that the destinations of vehicle V1 and vehicle V2 are classified in a common category, and the destination of vehicle V3 is classified in a different category, the controller 21 selects the destinations to which the two vehicles V1 and V2 are heading, having a common characteristic of being classified in the common category. Each area is, for example, a large facility such as a station or an airport, or a district such as a municipality. Each category is, for example, a type of location such as restaurant, hotel, sightseeing spot, park, amusement park, movie theater, convenience store, supermarket, shopping mall, department store, pharmacy, station, airport, parking lot, hospital, post office, or bank.

In step S306, the controller 21 adjusts the content of an advertisement 14 according to the common characteristic of the plurality of destinations selected in step S305. For example, the controller 21 acquires, from the memory 22 or external storage, advertising text, an advertising image, or a combination thereof regarding a POI that exists in the same area as the selected plurality of destinations. Alternatively, the controller 21 acquires, from the memory 22 or external storage, advertising text, an advertising image, or a combination thereof regarding a POI that is classified in the same category as the selected plurality of destinations. The controller 21 edits the acquired advertising text, the acquired advertising image, or a combination thereof to generate an advertisement 14 for display. Then, the controller 21 performs the process in step S309.

The processes in step S307 to step S309 are the same as the processes in step S107 to step S109 of FIG. 3, and thus descriptions thereof are omitted.

As described above, in the present embodiment, in a case in which data indicating destinations of two or more vehicles V1, V2, . . . , Vn traveling through the section 13 simultaneously is acquired as the destination data D1, the controller 21 of the control apparatus 20 selects at least one destination from among the destinations indicated by the destination data D1. In a case in which a plurality of destinations having a common characteristic is included in the destinations indicated by the destination data D1, the plurality of destinations having the common characteristic is selected as the at least one destination. In a case in which a plurality of destinations having a common characteristic is not included, one destination is selected as the at least one destination. The controller 21 adjusts the content of an advertisement 14 according to the selected destination. In a case in which the plurality of destinations is selected, the content of the advertisement 14 is adjusted according to the common characteristic of the plurality of destinations.

According to the present embodiment, it is expected that the advertisement 14 may be even more effective in promotion.

As a variation of the third embodiment, the changes from the first embodiment to the second embodiment may be applied to the third embodiment. A fourth embodiment, such a variation, will be described.

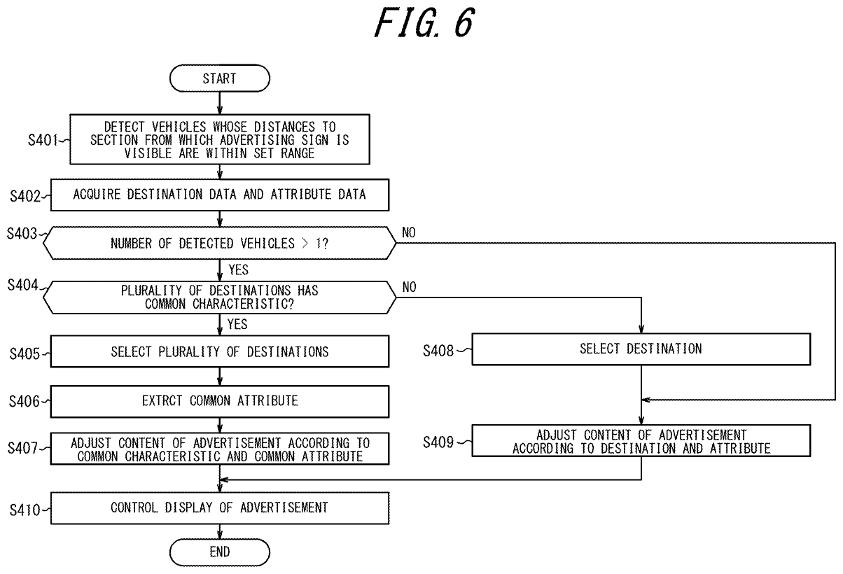

Operations of the system 10 according to the present embodiment will be described with reference to FIG. 6. These operations correspond to an advertisement display method according to the present embodiment. FIG. 6 illustrates operations of the control apparatus 20.

The process in step S401 is the same as the process in step S301 of FIG. 5, and thus a description thereof is omitted.

The process in step S402 is the same as the process in step S202 of FIG. 4, and thus a description thereof is omitted.

The processes in step S403 to step S405 are the same as the processes in step S303 to step S305 of FIG. 5, and thus descriptions thereof are omitted.

In step S406, the controller 21 extracts a common attribute of people who are on board vehicles Va, Vb, . . . that are heading to a plurality of destinations having a common characteristic, among the two or more vehicles V1, V2, . . . , Vn detected in step S401. In the present embodiment, the controller 21 extracts the common attribute with reference to the attribute data D4 acquired in step S402. For example, assuming that three persons, a 21-year-old, a 25-year-old, and a 29-year-old are on board vehicles Va, Vb, . . . , the controller 21 extracts a common attribute of “20s”.

In step S407, the controller 21 adjusts the content of an advertisement 14 according to the common characteristic of the plurality of destinations selected in step S405 and the common attribute extracted in step S406. For example, the controller 21 acquires, from the memory 22 or external storage, advertising text, an advertising image, or a combination thereof regarding a POI that exists in the same area as the selected plurality of destinations and popular with people having the extracted attribute. Alternatively, the controller 21 acquires, from the memory 22 or external storage, advertising text, an advertising image, or a combination thereof regarding a POI that is classified in the same category as the selected plurality of destinations and popular with people having the extracted attribute. The controller 21 edits the acquired advertising text, the acquired advertising image, or a combination thereof to generate an advertisement 14 for display. Then, the controller 21 performs the process in step S410.

The process in step S408 is the same as the process in step S307 of FIG. 5, and thus a description thereof is omitted.

The process in step S409 is the same as the process in step S209 of FIG. 4, and thus a description thereof is omitted.

The process in step S410 is the same as the process in step S309 of FIG. 5, and thus a description thereof is omitted.

The present disclosure is not limited to the embodiments described above. For example, a plurality of blocks described in the block diagrams may be integrated, or a block may be divided. Instead of executing a plurality of steps described in the flowcharts in chronological order in accordance with the description, the plurality of steps may be executed in parallel or in a different order according to the processing capability of the apparatus that executes each step, or as required. Other modifications can be made without departing from the spirit of the present disclosure.

For example, the control apparatus 20 may be integrated into the advertising sign 30.

1. A control apparatus comprising a controller configured to:
acquire destination data indicating a destination of at least one vehicle; and
when the at least one vehicle travels through a section, on a road, from which an advertising sign installed outdoors is visible, perform control to display, on the advertising sign, an advertisement that is customized according to the destination indicated by the destination data.

2. The control apparatus according to claim 1, wherein the controller is configured to detect, as the at least one vehicle, a vehicle whose distance to the section is within a set range.

3. The control apparatus according to claim 1, wherein in a case in which data indicating destinations of two or more vehicles traveling through the section simultaneously is acquired as the destination data, the controller selects at least one destination from among the destinations indicated by the destination data, and adjusts content of the advertisement according to the selected destination.

4. The control apparatus according to claim 3, wherein in a case in which a common destination of a plurality of vehicles is included in the destinations indicated by the destination data, the controller selects the common destination as the at least one destination.

5. The control apparatus according to claim 4, wherein the controller is configured to select, as the common destination, a destination to which a largest number of vehicles among the two or more vehicles are heading.

6. The control apparatus according to claim 4, wherein in a case in which the common destination is selected, the controller extracts a common attribute of people who are on board the plurality of vehicles, and further adjusts the content of the advertisement according to the common attribute.

7. The control apparatus according to claim 3, wherein in a case in which a plurality of destinations having a common characteristic is included in the destinations indicated by the destination data, the controller selects the plurality of destinations having the common characteristic as the at least one destination, and adjusts the content of the advertisement according to the common characteristic.

8. The control apparatus according to claim 7, wherein in a case in which the plurality of destinations exists in a common area, the controller adjusts the content of the advertisement according to the common area as the common characteristic.

9. The control apparatus according to claim 7, wherein in a case in which the plurality of destinations is classified in a common category, the controller adjusts the content of the advertisement according to the common category as the common characteristic.

10. The control apparatus according to claim 7, wherein in a case in which the plurality of destinations is selected, the controller extracts a common attribute of people who are on board vehicles heading to the plurality of destinations among the two or more vehicles, and further adjusts the content of the advertisement according to the common attribute.

11. A system comprising:
the control apparatus according to claim 1; and
the advertising sign.

12. The control apparatus according to claim 1, further comprising a communication interface configured to receive the destination data,
wherein the controller is configured to acquire the destination data received by the communication interface.

13. The control apparatus according to claim 12, wherein the communication interface is configured to receive the destination data from a terminal apparatus mounted or installed in the at least one vehicle.

14. A system comprising:
the control apparatus according to claim 13; and
the terminal apparatus.

15. The control apparatus according to claim 12, wherein the communication interface is configured to receive the destination data from a terminal apparatus held by a person who is on board the at least one vehicle.

16. A system comprising:
the control apparatus according to claim 15; and
the terminal apparatus.

17. A non-transitory computer readable medium storing a program configured to cause a computer to execute operations, the operations comprising:
acquiring destination data indicating a destination of at least one vehicle; and
when the at least one vehicle travels through a section, on a road, from which an advertising sign installed outdoors is visible, performing control to display, on the advertising sign, an advertisement that is customized according to the destination indicated by the destination data.

18. The non-transitory computer readable medium according to claim 17, wherein the operations further comprise:
in a case in which data indicating destinations of two or more vehicles traveling through the section simultaneously is acquired as the destination data, selecting at least one destination from among the destinations indicated by the destination data; and
adjusting content of the advertisement according to the selected destination.

19. An advertisement display method comprising:
acquiring, by a computer, destination data indicating a destination of at least one vehicle; and
when the at least one vehicle travels through a section, on a road, from which an advertising sign installed outdoors is visible, displaying, on the advertising sign, an advertisement that is customized according to the destination indicated by the destination data.

20. The advertisement display method according to claim 19, further comprising:
in a case in which data indicating destinations of two or more vehicles traveling through the section simultaneously is acquired as the destination data, selecting, by the computer, at least one destination from among the destinations indicated by the destination data; and
adjusting, by the computer, content of the advertisement according to the selected destination.
